(19) United States
(12) Patent Application Publication
(10) Pub. No.: US 2009/0194987 A1
(43) Pub. Date: Aug. 6, 2009

(54) METHOD, APPARATUS AND MEDICATION STORAGE DEVICE FOR EFFICIENTLY GENERATING MEDICATION LABELS

(75) Inventors: Melanie Ann Christie, Butler, PA (US); Jeffrey John Thompson, Allison Park, PA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Automation Inc.

(21) Appl. No.: 12/023,403

(22) Filed: Jan. 31, 2008

(51) Int. Cl. B42D 15/00

(52) U.S. Cl. 283/70

(57) ABSTRACT

A method, apparatus and medication storage device are provided for automatically generating labels for medication receptacles. The labels generated may include information about the medication contained in the receptacle that was both received from a healthcare worker at the time of dispensing the medication (e.g., the name (brand and/or generic) of the medication, the amount dispensed, etc.) and retrieved from a central database or server storing information about a plurality of medications (e.g., medication strength, form, etc.).

### FIELD

Embodiments of the invention relate, generally, to medication labels and, in particular, to efficiently generating labels for medication receptacles.

### BACKGROUND

The Joint Commission on Accreditation of Healthcare Organizations (JCAHO) has listed as a patient safety goal that all healthcare providers label all medications and medication containers or receptacles (e.g., syringes, medicine cups, basins, vials, test tubes, etc.). Certain issues exist in attempting to meet this goal in relation to labeling medications that have been “drawn up” into one or more syringes for use in a particular procedure or case. In particular, only a very small percentage of institutions (e.g., hospitals, etc.) prepare or purchase pre-filled syringes for use in operating rooms and surgery centers. While pre-filled syringes are becoming increasingly available, they can be costly and limitations in size often result in increased waste. As a result, a large percentage (if not all) of the medications stored for use by healthcare workers, such as but not limited to anesthesia providers, are in the form of a vial or ampule. In order to be administered to the patient, these medications need to be drawn into a syringe. An anesthesia provider, or other healthcare worker, may need to draw up several syringes for each patient case, and have several patient cases in one day. This may result in a fair number of syringes needing to be labeled within a given day.

Often times, operating rooms and surgery centers have high case turnover. As a result, anesthesia providers and other healthcare workers are sometimes left with a very short amount of time (e.g., 12 minutes) between patient cases, during which they need to prepare for the next case. Preparation may include speaking with the patient, drawing up medications, and gathering supplies. This may leave little time for labeling the drawn up syringes.

There are several manufacturers on the market today that offer anesthesia syringe labels. These labels are industry standard and widely used. One issue with these labels may be that they require the anesthesia provider, at the time the medication is drawn into the syringe, to hand-write on the label the strength of the medication being drawn up, the date and time of dispensing, his or her initials, and the like. However, in light of the issues described above (e.g., lack of time between cases), it appears that this is rarely done. In practice, the information may either never be filled out, or filled out at a later time (i.e., not at the time the medication is drawn into the syringe, as recommended). In addition, many existing pre-made “fill-in-the-blank” syringe labels do not allow for other fields that are recommended by the American Society of Anesthesiologists (ASA), such as a manufacturer, brand name, lot number, and expiration date.

Another solution has been for a pharmacy to provide syringe labeling (i.e., rather than the healthcare worker drawing up and labeling syringes and other medication dispensing devices at the time of each case or procedure). In this scenario, the pharmacy may anticipate what medications are needed for a given period of time (e.g., a workday) and then draw up and label those medications. However, this solution can be expensive, since many medications (and dollars) may be wasted on unused medications when the medications actually needed differ from what the pharmacy anticipated, which may often occur. This solution may further require additional pharmacy labor adding additional cost.

A need, therefore, exists for a technique for labeling medication receptacles, such as syringes or other medication dispensing devices, that addresses these and other issues.

### BRIEF SUMMARY

In general, embodiments of the present invention provide an improvement by, among other things, providing a system and procedure for automatically generating labels for medication receptacles (e.g., syringes, medicine cups, basins, vials, test tubes, etc.) that include information about the medication that is based on both information received from the healthcare worker at the time of dispensing the medication and information retrieved from a central database or server storing information about a plurality of medications.

In accordance with one aspect, a method is provided of automatically generating a label for a medication receptacle. In one embodiment, the method may include: (1) receiving identification information associated with a medication to be dispensed; (2) receiving information associated with an amount of the medication to be dispensed, wherein the amount information includes a volume of the medication being drawn into a medication receptacle; and (3) generating a label for attaching to the medication receptacle, wherein the label comprises the identification and amount information received.

In accordance with another aspect, an apparatus is provided for automatically generating a label for a medication receptacle. In one embodiment, the apparatus may include a processor configured to: (1) receive identification information associated with a medication to be dispensed; (2) receive information associated with an amount of the medication to be dispensed, wherein the amount information includes a volume of the medication being drawn into a medication receptacle; and (3) generate a label for attaching to the medication receptacle, wherein the label comprises the identification and amount information received.

According to yet another aspect, a medication storage device is provided that is configured to automatically generate a label for a medication receptacle. In one embodiment the medication storage device may include a computing device that is configured to: (1) receive identification information associated with a medication to be dispensed; (2) receive information associated with an amount of the medication to be dispensed, wherein the amount information includes a volume of the medication being drawn into a medication receptacle; and (3) generate a label for attaching to the medication receptacle, wherein the label comprises the identification and amount information received.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1A is a block diagram of one type of system that would benefit from embodiments of the present invention;

FIG. 1B illustrates a mobile medication dispensing cart of one embodiment of the present invention;

FIG. 2 is a schematic block diagram of an entity capable of operating as a computing device operating on the medication storage device in accordance with embodiments of the present invention;

FIG. 3 is flow chart illustrating the process of generating a medication receptacle label in accordance with an embodiment of the present invention;

FIGS. 4A and 4B illustrate a user interface for generating a medication receptacle label in accordance with an embodiment of the present invention; and

FIG. 5 provides an example of a label generated in accordance with an embodiment of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide a method, apparatus and medication storage device for automatically generating labels for use on medication receptacles including, for example, vials, test tubes, basins, and/or medication dispensing devices such as syringes. In one embodiment, a healthcare worker may first provide identification information associated with a medication he or she would like to dispense. This may include, for example, the brand or generic name of the medication, a national drug code, or the like. Using the identity of the medication, additional information associated with the medication may be retrieved from a central server or database. This may include, for example, the strength of the medication, the form of the medication, additional identification information (brand or generic name and/or national drug code if not provided by the healthcare worker), or the like. The healthcare worker may then be prompted to provide information regarding the amount of the medication to be dispensed. Using the information received from the healthcare worker, information associated with the healthcare worker him or herself (e.g., his or her name), information retrieved from the central server or database, and, in one embodiment, color coding information, a label may be generated for affixing to the medication receptacle.

Many current medication management solutions do not provide strong incentives or benefits for the healthcare worker (e.g., anesthesiologist) to track medications being removed from a medication storage device (e.g., medication dispensing cart or cabinet, nurse server, medication carousel or shelving, etc.) unless the substances are controlled and require reporting. This can lead to inventory related issues. By providing the healthcare worker with a label for the medication receptacle that is pre-printed with all of the necessary information in order to comply with various regulations, embodiments of the present invention provide a positive incentive for the healthcare worker (e.g., anesthesia provider) to identify drug use and enter that information accurately and timely into the system.

In addition, as noted above and discussed in more detail below, a significant amount of the information used in generating the label may be previously stored within a central server or database accessible by the healthcare worker's computing device. As a result, the amount of information the healthcare worker is required to separately input in order to generate the label is substantially reduced. This elimination of redundant data entry may serve to reduce the risk of inconsistencies, as well as increase the efficiency associated with label generation.

### Overall System and Medication Cart:

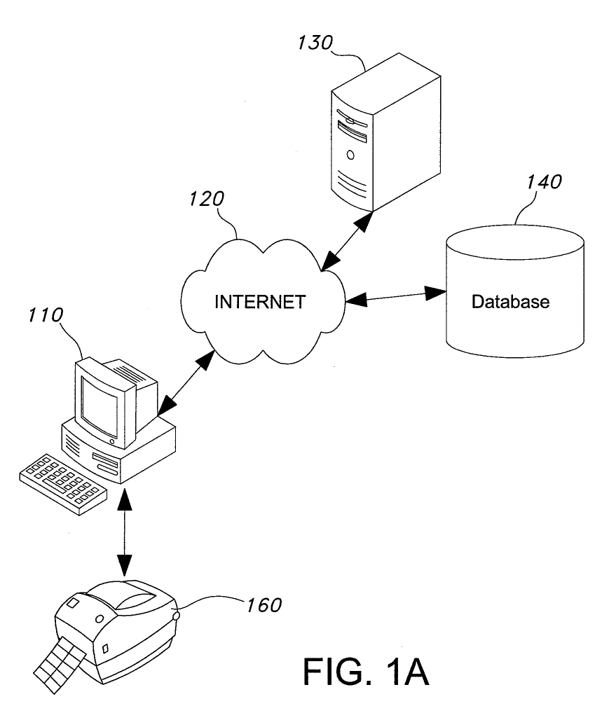

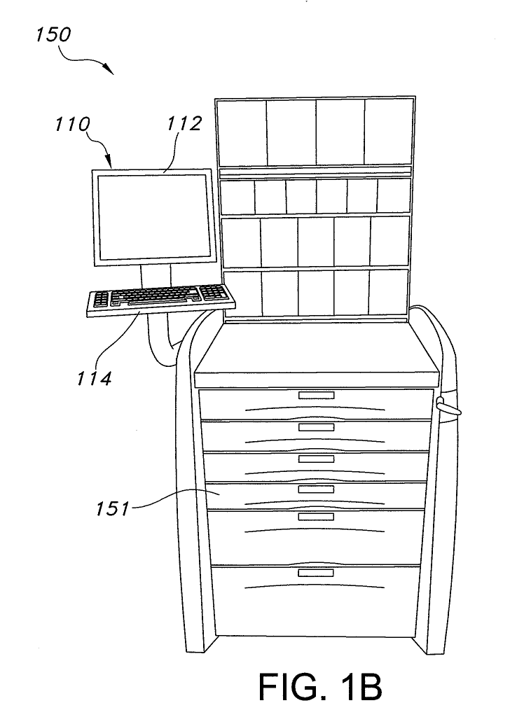

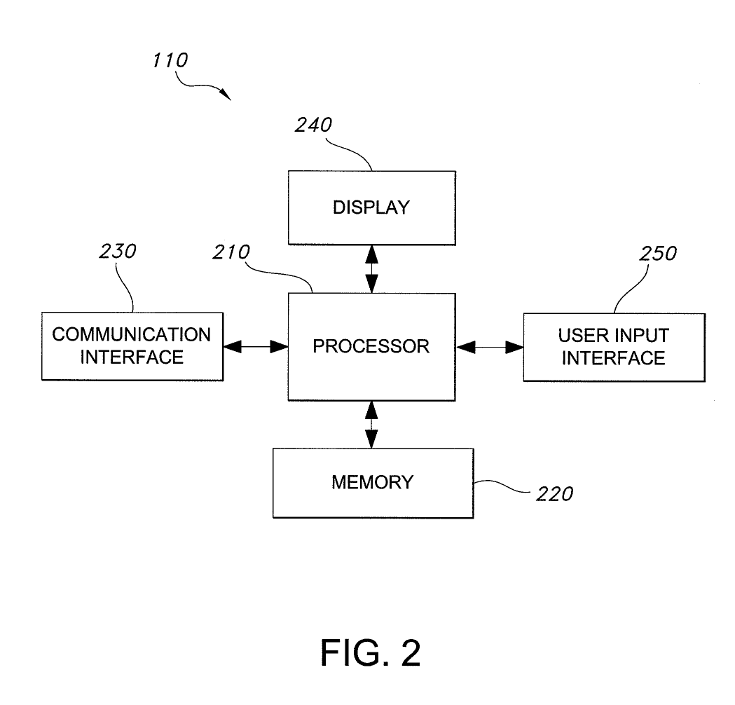

Referring to FIG. 1A, an illustration of one type of system that would benefit from embodiments of the present invention is provided. As shown, the system may include a computing device 110, which is discussed in more detail below with regard to FIG. 2, and which may be configured to generate a label for a medication receptacle in accordance with an embodiment of the present invention. As shown in FIG. 1B, in one embodiment, the computing device 110 may be operated in association with a mobile medication dispensing cart 150 used for storing and dispensing various medications. As one of ordinary skill in the art will recognize, the computing device 110 may be operated in association with any type of medication storage device including, but not limited to, the medication cart 150 shown in FIG. 1B. In particular, according to other embodiments, the computing device 110 may be operated in association with a medication cabinet, a nurse server, various types of pharmacy medication storage equipment (e.g., a medication carousel, medication shelving, etc.), or the like. Accordingly, while embodiments herein describe the computing device 110 as being operated in association with the medication cart 150, embodiments of the present invention are not so limited.

Referring to FIG. 1B, the medication cart 150 of one embodiment may include one or more drawers 151 for storing various medications and medication dispensing devices (e.g., syringes) used by a healthcare worker within a given period of time (e.g., throughout his or her workday). Using the computing device 110, a healthcare worker may input information regarding a medication he or she is dispensing from at least one of the drawers 151 of the medication cart (e.g., the medication name and amount). Accordingly, the computing device 110 may include a display screen 112, a keyboard 114, and/or other input and/or output devices, which are not shown and which may include, for example, a speaker, a barcode reader, a radio frequency identification (RFID) tag reader, and the like. In particular, according to one embodiment, in order to input identification information associated with the medication being dispensed, the healthcare worker may use a barcode reader associated with the computing device 110 to scan a barcode displayed on the medication.

The system may further include a central server 130, or similar network entity, associated with a healthcare facility in which the computing device 110 (and, in one embodiment, the corresponding medication cart 150 or similar medication storage device) is being used. The computing device 110 may access the central server 130 via a communication network 120 in order to request additional information regarding the medication being dispensed by the healthcare worker. The communication network 120 may include any wired or wireless communication network including, for example, a wired or wireless local area network (LAN), personal area network (PAN), metropolitan area network (MAN), wide area network (WAN), or the like.

In response to receiving the request from the computing device 110, the central server 130 may retrieve the requested information from a database 140 in association with the central server 130. In one embodiment, the database 140 may store information associated with a plurality of medications including, for example, the brand name, the generic name, the national drug code, the medication strength, the medication form, and the like. In an alternative embodiment, some or all of the additional information associated with the medication being dispensed by the healthcare worker may be stored locally in memory associated with the computing device 110, thus eliminating the need for the computing device 110 to request this information from the central server 130 or at least reducing the amount of information that needs to be requested.

Finally, the system may further include a label printer 160 (e.g., a color label printer) in electronic communication with the computing device 110 for printing a label generated by the computing device 110 using the information input by the healthcare worker, as well as the information retrieved from the central server 130 and database 140 and/or the memory on the computing device 110.

Referring now to FIG. 2, a block diagram of an entity capable of operating as the computing device 110 operating on a medication storage device, such as the medication cart 150, is shown in accordance with one embodiment of the present invention. The entity capable of operating as the computing device 110 includes various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as the computing device 110 can generally include means, such as a processor 210 for performing or controlling the various functions of the entity.

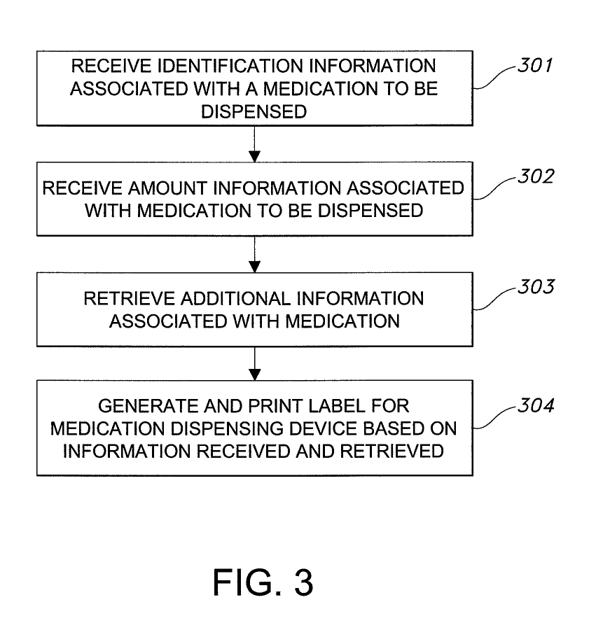

In particular, as discussed in more detail below with regard to FIG. 3, according to one embodiment, the processor 210 may be configured to receive identification and amount information associated with a medication to be dispensed (e.g., as input from the healthcare worker) and to use the identification information to retrieve additional information associated with the identified medication (e.g., from the central server or database). The processor 210 may further be configured to then generate a label for attaching to a medication receptacle (e.g., a syringe), wherein the label includes the identification and amount information received, as well as the additional information retrieved.

In one embodiment, the processor is in communication with or includes memory 220, such as volatile and/or non-volatile memory that stores content, data or the like. For example, the memory 220 typically stores content transmitted from, and/or received by, the entity. Also for example, the memory 220 typically stores software applications, instructions or the like for the processor to perform steps associated with operation of the entity in accordance with embodiments of the present invention. In particular, according to one embodiment, the memory 220 may store computer program code for instructing the processor 210 to perform the steps discussed above and below with regard to FIG. 3.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

### Method of Automatically Generating a Medication Label

Referring now to FIG. 3, the operations are illustrated that may be taken in order to automatically print a label for a medication receptacle (e.g., vial, test tube, basin, syringe, etc.) in accordance with embodiments of the present invention. As shown, the process may begin, at Block 301, when the computing device (e.g., personal computer (PC), laptop, etc.), and in particular a processor or similar means operating on the computing device, receives identification information associated with a medication to be dispensed. As discussed above, this may occur when a healthcare worker, such as an anesthesia provider, uses the keyboard, barcode reader, or other input device associated with the computing device to input, for example, the brand or generic name of the medication, the national drug code associated with the medication, or the like. In one embodiment, the healthcare worker may input the medication identification information by selecting one of a plurality of medication names or national drug codes displayed on the display screen of the computing device. Alternatively, the healthcare worker may manually input the identification information via the keyboard or by scanning a barcode associated with the medication.

The healthcare worker may thereafter further provide information regarding the amount of the medication he or she is dispensing. This information, which may be received by the computing device (e.g., the processor or similar means operating on the computing device) at Block 302, may include, for example, the number of vials or containers of medication involved, as well as the volume (e.g., in milliliters (ML)) of the medication actually being drawn up into a syringe or other dispensing device, or otherwise dispensed. Using the identification information received from the healthcare worker at Block 301, the computing device (e.g., processor or similar means) may further retrieve additional information associated with the medication being dispensed. (Block 303). As described above, this may involve accessing a central server and/or corresponding database associated with the healthcare facility in which the computing device is in use. Alternatively, or in addition, this may involve accessing memory associated with the computing device in order to retrieve medication information stored locally on the computing device. Regardless of the origin, the information retrieved may include, for example, the brand and/or generic name of the medication, the medication strength (i.e., amount per dose), the medication form, and the like. The information may further include the location of the medication (e.g., a drawer and/or pocket of a medication cart in which the medication is stored and with which the computing device is associated), as well as the inventory of the medication, for example, within a corresponding pharmacy, medication storage device (e.g., medication cart or cabinet, nurse server, medication carousel or shelving, etc.) or overall medical facility.

While FIG. 3 illustrates the computing device as receiving the information associated with the amount of the medication being dispensed prior to retrieving any additional information associated with the identified medication, as one of ordinary skill in the art will recognize, once the computing device has received the identification information associated with the medication, the computing device (e.g., processor or similar means operating on the computing device) may at any time, and as many different times as desired, retrieve additional information associated with the identified medication.

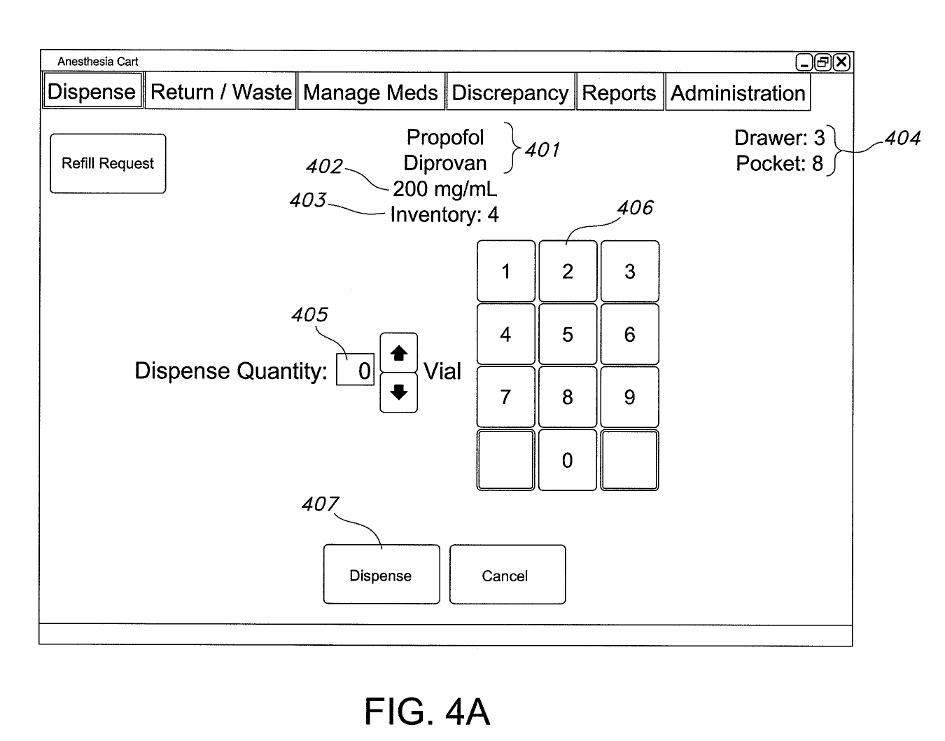

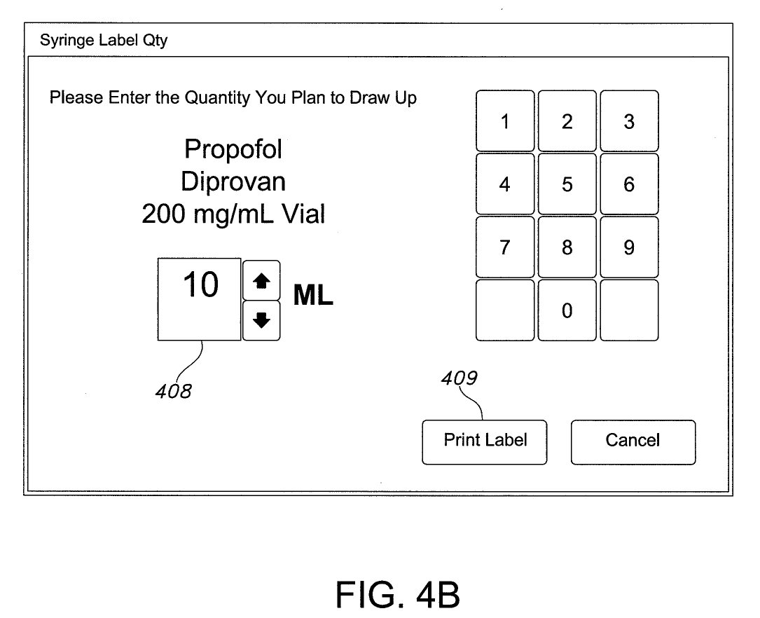

To illustrate, reference is made to FIGS. 4A and 4B, which provide an example of a user interface which may be provided by the computing device and used by the healthcare worker in order to provide information regarding the amount of the medication to be dispensed. In particular, FIG. 4A illustrates the screen a healthcare worker may see in one embodiment of the present invention after he or she has provided information identifying the medication to be dispensed. As shown, this screen may include information, such as the brand and generic name of the medication 401, the strength of the medication 403, the inventory associated with the medication within a corresponding medication storage device (e.g., medication cart) 403, the location of the medication in the cart 404, and the like. According to embodiments of the present invention, some or all of this information may have been retrieved by the computing device (e.g., processor or similar means operating on the computing device) from the central server and/or computing device memory using the identification information provided by the healthcare worker.

The healthcare worker may input the number of vials he or she would like to dispense 405, for example using a keypad 406 displayed on the user interface, and then select the “Dispense” button or tab 407 in order to proceed to the screen shown in FIG. 4B. Using the screen of FIG. 4B, the healthcare worker may input the volume 408 of the medication he or she is dispensing, and then request that a label be printed by selecting the “Print Label” button displayed on the screen.

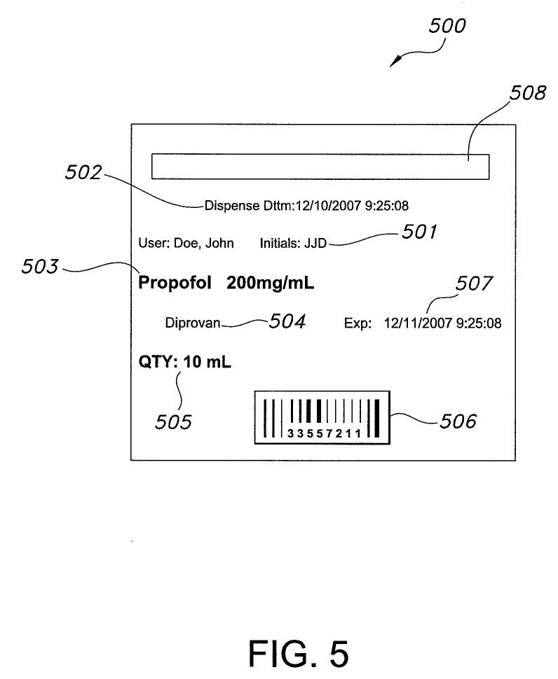

Returning to FIG. 3, in response to the healthcare worker selecting the “Print Label” button, the computing device (e.g., processor or similar means operating on the computing device) may use the information received from the healthcare worker at Blocks 301 and 302, as well as the information retrieved from the central server and/or memory of the computing device at Block 303 to generate and print, at Block 304, a label which can be applied to the medication receptacle (e.g., syringe) associated with the medication. An example of a label 500 that may be generated in accordance with embodiments of the present invention is provided in FIG. 5.

As shown in FIG. 5, the label of one embodiment may include any combination of the following: the healthcare worker's name and initials 501, the date and time at which the medication was dispensed 502, the brand name and strength of the medication 503, the generic name of the medication 504, the volume or amount of the medication dispensed 505, a barcode associated with the medication 506 and including, for example, the national drug code associated with the medication, an expiration date and time 507 associated with the medication, a color indicator 508 (discussed below), and the like. The label may further include a designated space in which the healthcare worker may hand-write his or her initials on the label. In addition, while not shown, the label may further include information associated with the patient for whom the medication has been prepared (e.g., patient name, social security number, unique identification number, etc.).

With regard to the color indicator 508, there appears to exist an industry preference of using color to identify anesthesia medication categories. The working environment of an anesthesia provider can be filled with distractions and emergency situations. Many of the medications used in anesthesia look alike, but have widely different effects on a patient. These include medications such as muscle relaxants, vasopressors, and vasodilators. In order to aid the anesthesia provider in a chaotic time, some institutions prefer to use color to identify medication categories. For example, induction agents may be identified by yellow, while tranquilizers may appear with orange labels. The thought appears to be that in an emergency, if the doctor does not have time to read all data elements on a label, he or she can at least take a medication in the correct medication category, as indicated by the color. For those institutions that rely on color as an aid in medication safety, having the color on the label may be seen as a necessity. As a result, in one embodiment of the present invention, the label 500 may include a circle, square, or some other object or form that is of the color associated with the category in which the corresponding medication is included.

In one embodiment, the barcode 506 included on the label may be used when returning or wasting the medication and/or to allow the user to scan the filled medication receptacle (e.g., syringe) immediately before administration of the medication in order to document the administration and also to provide nay medication/patient alerts. In a further embodiment, the expiration date 507 displayed on the label may be calculated based on the date on which the medication was dispensed 502. For example, the expiration date 507 may be equal to 24 hours after the date of dispensing 502.

As one of ordinary skill in the art will recognize, the foregoing examples of information that may be included on the generated label are provided for exemplary purposes only and should not be taken in any way as limiting the scope of embodiments of the invention to the specific information items and/or format of those items described. In fact, according to embodiments of the present invention, the generated labels may be configurable by the healthcare worker, administrator associated with the healthcare facility in which the labels are being generated, or other individual, to include any combination and format of information deemed appropriate for that individual and/or facility.

According to embodiments of the present invention, the automatic generation of labels including all of the necessary information for adequately labeling a medication receptacle may provide an incentive to healthcare workers (e.g., anesthesia providers) to input information regarding the medications they are dispensing into the system operating in association with the healthcare facility in which they are working. The information input may thereafter be used for managing and tracking inventory; thus providing an additional benefit to the healthcare facility as a whole.

### CONCLUSION

As described above and as will be appreciated by one skilled in the art, embodiments of the present invention may be configured as a method, apparatus and medication storage device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 210 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 210 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving identification information associated with a medication to be dispensed;
receiving information associated with an amount of the medication to be dispensed, said amount information comprising a volume of the medication being drawn into a medication receptacle; and
generating a label for attaching to the medication receptacle, wherein the label comprises the identification and amount information received.

2. The method of claim 1, further comprising:
retrieving additional information associated with the medication based at least in part on the identification information received, wherein the label further comprises the additional information retrieved.

3. The method of claim 1, wherein the label further comprises information associated with a user from whom the identification and amount information is received.

4. The method of claim 1 further comprising:
determining a color associated with the medication, wherein the label comprises an indication of the determined color.

5. The method of claim 1 further comprising:
determining an expiration date associated with the medication, wherein the label comprises an indication of the determined expiration date.

6. The method of claim 1, wherein the identification information received comprises at least one of a brand name, generic name and a national drug code associated with the medication, or a combination thereof.

7. The method of claim 1, wherein the additional information retrieved comprises at least one of a strength, form, route, brand name, generic name or national drug code associated with the medication, or a combination thereof.

8. The method of claim 1, wherein retrieving additional information comprises retrieving the additional information from a central server.

9. The method of claim 1 further comprising:
receiving an indication of a requested field to include in the label, wherein generating the label comprises generating a label including the requested field.

10. The method of claim 1, wherein the label comprises a machine-readable code in which information associated with the medication is embedded.

11. An apparatus comprising:
a processor configured to:
receive identification information associated with a medication to be dispensed;
receive information associated with an amount of the medication to be dispensed, said amount information comprising a volume of the medication being drawn into a medication receptacle; and
generate a label for attaching to the medication receptacle, wherein the label comprises the identification and amount information received.

12. The apparatus of claim 11, wherein the processor is further configured to:
retrieve additional information associated with the medication based at least in part on the identification information received, and wherein the label further comprises the additional information retrieved.

13. The apparatus of claim 11, wherein the label further comprises information associated with a user from whom the identification and amount information is received.

14. The apparatus of claim 11, wherein the processor is further configured to:
determine a color associated with the medication, wherein the label comprises an indication of the determined color.

15. The apparatus of claim 11, wherein the processor is further configured to:
determine an expiration date associated with the medication, wherein the label comprises an indication of the determined expiration date.

16. The apparatus of claim 11, wherein the additional information retrieved comprises at least one of a strength, form, route, brand name, generic name or national drug code associated with the medication, or a combination thereof.

17. The apparatus of claim 11, wherein in order to retrieve additional information, the processor is further configured to retrieve the additional information from a central server.

18. The apparatus of claim 11, wherein the processor is further configured to:
receive an indication of a requested field to include in the label, wherein in order to generate the label, the processor is further configured to generate a label including the requested field.

19. A medication storage device comprising:
a computing device configured to:
receive identification information associated with a medication to be dispensed;
receive information associated with an amount of the medication to be dispensed, said amount information comprising a volume of the medication being drawn into a medication receptacle; and
generate a label for attaching to the medication receptacle, wherein the label comprises the identification and amount information received.

20. The medication storage device of claim 19, wherein the computing device is further configured to:
retrieve additional information associated with the medication based at least in part on the identification information received, and wherein the label further comprises the additional information retrieved.

21. The medication storage device of claim 19, wherein the label further comprises information associated with a user from whom the identification and amount information is received.

22. The medication storage device of claim 19, wherein the computing device is further configured to:
determine a color associated with the medication, wherein the label comprises an indication of the determined color.

23. The medication storage device of claim 22 further comprising:
a color printer configured to print the label including the indication of the determined color.

24. The medication storage device of claim 19, wherein the computing device is further configured to:
determine an expiration date associated with the medication, wherein the label comprises an indication of the determined expiration date.

25. The medication storage device of claim 19, wherein the identification information received comprises at least one of a brand name, generic name and a national drug code associated with the medication, or a combination thereof.

26. The medication storage device of claim 19, wherein the additional information retrieved comprises at least one of a strength, form, route, brand name, generic name or national drug code associated with the medication, or a combination thereof.

27. The medication storage device of claim 19, wherein in order to retrieve additional information the computing device is further configured to retrieve the additional information from a central server.

28. The medication storage device of claim 19, wherein the computing device is further configured to:
receive an indication of a requested field to include in the label, wherein in order to generate the label, the computing device is further configured to generate a label including the requested field.
